(19) United States
(12) Patent Application Publication
(10) Pub. No.: US 2008/0091889 A1
(43) Pub. Date: Apr. 17, 2008

(54) MEMORY CONTROL APPARATUS

(75) Inventor: Masahiko Hayano, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/781,999

(22) Filed: Jul. 24, 2007

(30) Foreign Application Priority Data
Oct. 6, 2006 (JP) 2006-275564

(51) Int. Cl. G06F 12/00

(52) U.S. Cl. 711/154; 711/E12.001

(57) ABSTRACT

Problem: A master cannot use a built-in memory as an independent memory in the case where a memory does not use peripherals.

Solution: A memory control apparatus includes main memories (for example, RAM) 35-1, 35-2, peripherals 40-1, 40-2 having built-in memories (for example, RAM) 43-1, 43-2, a master 20 for accessing the main memoirs and the built-in memories, and a access mode setting register for setting the access mode of the access object. Furthermore, the memory control apparatus includes an address decoder 31 for decoding an address from the master 20 and outputting the decoding results, and selectors 42-1, 42-2 for selecting access information including the decoding results being given to the built-in memories corresponding to the set access mode.

### BACKGROUND OF THE INVENTION

1. Field of the Invention

The present invention relates to a memory control apparatus of semiconductor integrated circuits, etc. such as large-scale integrated circuit (hereinafter referred to as “LSI”).

This is a counterpart of Japanese patent application Serial Number 275564/2006, filed on Oct. 6, 2006, the subject matter of which is incorporated herein by reference.

Conventionally, a technology relating to a memory control apparatus for accessing a plural of memories (for example, memories rewritable and readable at any time) by a master is as in the description of the following documents.

2. Description of the Related Art

Patent document 1: Japanese Patent Kokai Number H05-127988

Patent document 2: Japanese Patent Kokai Number 2003-44306

FIG. 2 is a view of general configuration diagram of conventional memory control apparatus described in the patent documents 1, 2, etc.

The above memory control apparatus is configured by, for example, LSI and includes a master 1 for controlling the whole device; a system bus 2 consisting of a data bus 2a, an address bus 2b, and a control bus 2c; a RAM control circuit 3 connected to the above master 1 through the system bus 2; a plural (for example, two) of RAMs 4-1, 4-2 of the main memory connected to the above RAM control circuit 3; and a plural (for example, two) peripheral devices (hereinafter referred to as “peripheral”) 10-1, 10-2 connected to the above master 1 through the system bus 2.

The data bus 2a of system bus 2 is configured to transmit the read data RD and the write data WD, etc. The address bus 2b of the system bus 2 is configured to transmit the address AD of the access mode. The control bus 2c of the system bus 2 is configured to transmit the read/write (hereinafter referred to as “R/W”) control signal CS, etc. The RAM control circuit 3 includes an address decoder 3a, switching circuit 3b, and a selector 3c. The peripherals 10-1, 10-2 consist of control circuits 11-1, 11-2 having memory access function and RAMs 12-1, 12-2 of built-in memories, etc., respectively.

The operation of the memory control apparatus having the aforementioned configuration will be explained as follows.

The master 1 accesses the RAM control circuit 3 or peripherals 10-1, 10-2 corresponding to the address AD and the R/W control signal CS. The RAM control circuit 3 decodes the address AD from the master 1 by the address decoder 3a, and generates and outputs the addresses to the RAMs 4-1, 4-2, and the R/W control signal CS. In the case of read-out (read), the RAM control circuit 3 selects the read data RD from the RAMs 4-1, 4-2 corresponding to decoding results of the address decoder 3a and outputs the above selected read data RD to the master 1. In the case of write-in (write), the RAM control circuit 3 outputs the write data WD from the master 1 to the RAM 4-1, or 4-2 corresponding to decoding results of the address decoder 3a.

A built-in RAM 12-1 of the peripheral 10-1 is accessed only by a control circuit 11-1 of the peripheral 10-1. A built-in RAM 12-2 of the peripheral 10-2 is accessed only by a control circuit 11-2 of the peripheral 10-2.

### SUMMARY OF THE INVENTION

### Problem to be Solved

However, even when the peripherals 10-1, 10-2 of the conventional memory control apparatus includes the built-in RAMs 12-1, 12-2, the built-in RAMs 12-1, 12-2 can not be accessed by the RAM control circuit 3, and then there is a problem that the RAMs 12-1, 12-2 built in the peripheral can not be used as a RAM in the case where the peripherals 10-1, 10-2 are not used.

### Solution of the Problem

The memory control apparatus according to the present invention includes a main memory for storing data, a peripheral having a built-in memory for storing data, a master for outputting addresses to the above main memory and the above built-in memory to access the above main memory and the above built-in memory, a mode setting device for setting an access mode of the access object to the above main memory and the above built-in memory, a decoding device for decoding the above address from the above master based on the above set access mode and outputting the decoding results, and a selector for selecting the access information including the above decoding results corresponding to the above set access mode so as to provide the above built-in memory with the above selected access information.

### EFFECT OF THE INVENTION

According to the present invention, since the built-in memory can be used as an accessible memory by the master in the case where the peripheral including the built-in memory is not used, wider requests can be accepted.

### BRIEF DESCRIPTION OF THE DRAWINGS

FIG. 1: A view of general configuration diagram of a memory control apparatus according to the first embodiment.

FIG. 2: A view of general configuration diagram of a conventional memory control apparatus.

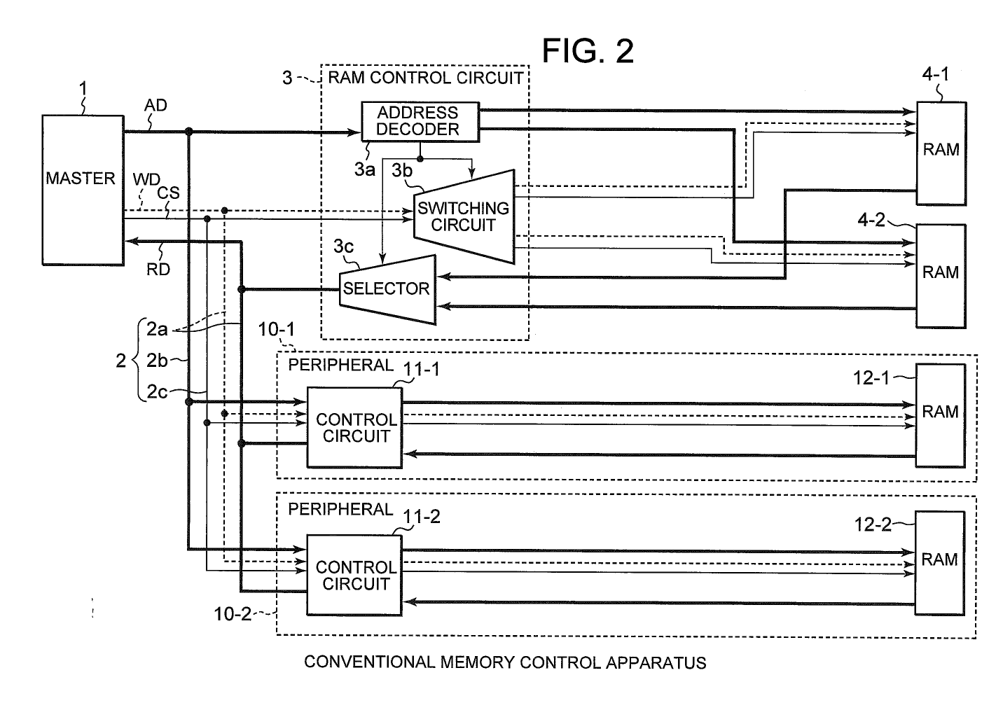

FIG. 3: A view of address map viewed from the master 20 of FIG. 1.

FIG. 4: A view of general configuration diagram of a memory control apparatus according to the second embodiment.

### DETAILED DESCRIPTION OF THE PREFERRED EMBODIMENTS

The memory control apparatus includes a main memory (for example, RAM), a peripheral having a built-in memory (for example, RAM), a master for outputting addresses to the above main memory and the above built-in memory and accessing the above main memory and the above built-in memory, a mode setting device for setting an access mode of the access object to the above main memory and the above built-in memory, a decoding circuit for decoding the above address from the above master based on the above set access mode and outputting the decoding results, and a selector for selecting the access information including the above decoding results corresponding to the above set access mode so as to provide the above built-in memory with the above selected access information.

### First Embodiment

Configuration of the first embodiment:

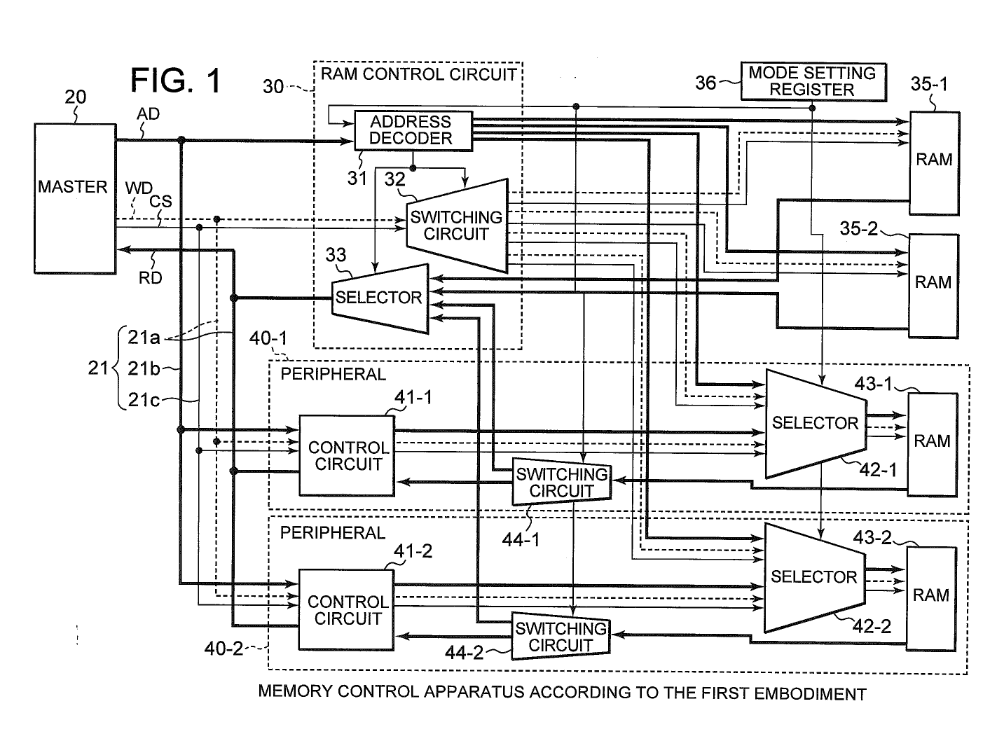

FIG. 1 is a view of general configuration diagram of a memory control apparatus according to the first embodiment of the present invention.

The above memory control apparatus consists of, for example, LSI, etc., and includes a master 20 such as a central processing unit (hereinafter referred to as “CPU”), etc., for programmed-controlling the whole device. The above master 20 is connected to a system bus 21. The system bus 21 consists of a data bus 21a for transmitting read data RD and write data WD, etc., an address bus 21b for transmitting an address AD of an access object, and a control bus 21c for transmitting a R/W control signal CS, etc.

The system bus 21 is connected to a plural (given number, for example, two) of main memories (for example, RAM) 35-1, 35-2 through a RAM control circuit 30, and simultaneously is connected to a plural (given number, for example, two) of peripherals 40-1, 40-2, such as USB controllers, etc., having built-in memories (for example, RAM) 43-1, 43-2, respectively. The above RAM control circuit 30 and the peripheral 40-1, 40-2 is connected to a mode setting device (for example, mode setting device register) 36. The mode setting register 36 is a register for setting an access mode of access objects of the RAMs 35-1, 35-2, 43-1, 43-2.

The RAM control circuit 30 has a function such as a bus bridge for connecting the system bus 21 and the RAMs 35-1, 35-2, 43-1, 43-2, and includes a decoding device (for example, an address decoder of a decoding circuit) 31, switching circuit 32, and a selector 33. The address decoder 31 decodes the address AD from the master 20 based on the access mode set by the mode setting register 36 to output the above decoding results and is connected to the switching circuit 32 and the selector 33.

The switching circuit 32 switches the write data WD and the R/W control signal CS from the master 20 corresponding to the decoding results and provides the RAMs 35-1, 35-2 and the peripherals 40-1, 40-2 with the above selected data or signal. The selector 33 selects the read data from the RAMs 35-1, 35-2, 43-1, 43-2 corresponding to the above decoding results and provides the master 20 with the above selected read data RD.

Peripherals 40-1, 40-2 consists of control circuits 41-1, 41-2, selectors 42-1, 42-2, built-in RAMs 43-1, 43-2 and switching circuits 44-1, 44-2, etc., respectively. The control circuits 41-1, 41-2 is connected to the system bus 21, controls the whole peripheral, and accesses the RAMs 43-1, 43-2, respectively. The above control circuits 41-1, 41-2 are connected to the selectors 42-1, 42-2, the RAMs 43-1, 43-2, and the switching circuit 44-1, 44-2, respectively.

The selectors 42-1, 42-2 selects one signal-set out of the set of decoding results, write data WD, and R/W control signal CS from the RAM control circuit 30, and the set of the address AD, write data WD, and R/W control signal CS from each of the control circuits 41-1, 41-2, based on the access mode set by the mode setting register 36, and provides the each of the RAMs 43-1, 43-2 with the above selected signal-set. The switching circuits 44-1, 44-2 switches the read data RD from the RAMs 43-1, 43-2, based on the access mode set by the mode setting register 36, and provides the selector 33 or the control circuits 41-1, 41-2 with the switched read data RD.

General Operation of the First Embodiment:

The master 20 accesses the RAM control circuit 30 and the peripherals 40-1, 40-2 according to the address AD and the R/W control signal CS. The RAM control circuit 30 decodes the access mode set by the mode register 36 and the address AD from the master 20, using the address decoder 31, and then generates and outputs the decoding results of the address AD to the RAMs 35-1, 35-2, 43-1, 43-2 and the R/W control signal CS. In the case of read, the read data RD from one out of the RAMs 35-1, 35-2, 43-1, and 43-2, is selected according to the decoding results of the address decoder 31, and outputted the above selected read data RD to the master 20.

In the case of write, the write data WD from the master 20 is outputted to one out of the RAMs 35-1, 35-2, 43-1, and 43-2 according to the decoding results of the address decoder 31. The built-in RAM 43-1 of the peripheral 40-1 is accessed by selecting the address AD, the R/W control signal CS, and the write data WD from the control circuit 41-1 or the RAM control circuit 30 using the selector 42-1. The built-in RAM 43-2 of the peripheral 40-2 is accessed by selecting the address AD, the R/W control signal CS, and the write data WD from the control circuit 41-2 of the peripheral 40-2 or the RAM control circuit 30 using the selector 42-2.

Detailed Operation of the First Embodiment:

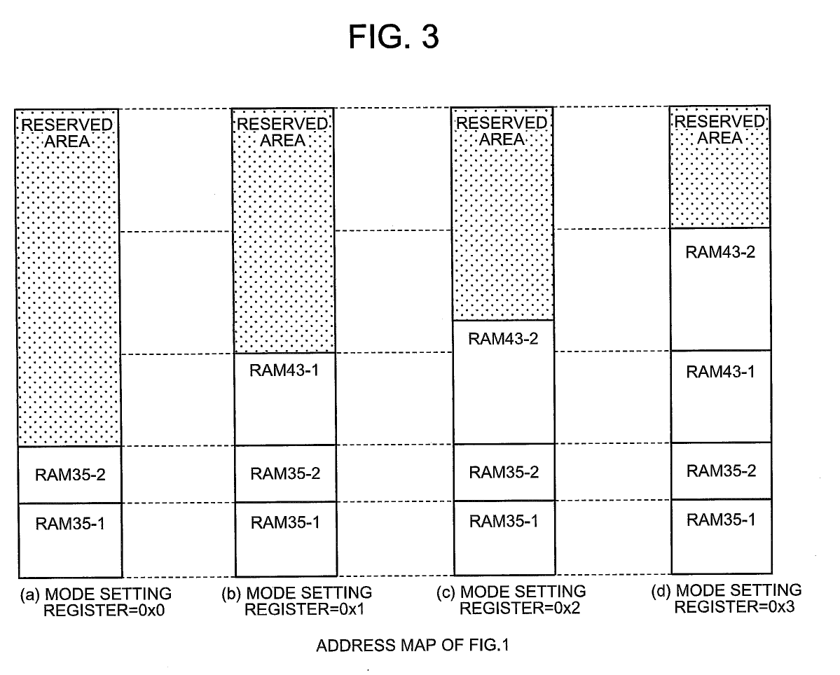

FIG. 3 (a) to (d) is a view of RAM address map viewed from the master 20 of FIG. 1. The “reserved region” of the FIG. 3 is a access-prohibited area assigned to no RAM or register, etc. being assigned thereto, and for example, there is a configuration that an error message is returned when the above access-prohibited area is accessed.

In the case where both of the peripherals 40-1, 40-2 are used, for example, ‘0x0’ is set in the mode setting register 36.

When the value of the mode setting register 36 is ‘0x0’, the address decoder 31 decodes the address AD to the RAM 35-1, or 35-2. The selector 42-1 of the peripheral 40-1 selects the address AD, R/W control signal CS, and the write data WD from the control circuit 41-1, according to the value of the mode setting register 36, and provides the RAM 43-1 with the above selected address, signal, and data. The selector 42-2 of the peripheral 40-2 selects the address AD, R/W control signal CS, and the write data WD from the control circuit 41-2, according to the value of the mode setting register 36, and provides the RAM 43-2 with the above selected address, signal, and data. The RAM address map viewed from the master 20 in the case where ‘0x0’ is set in the mode setting register 36 as explained before, is shown in FIG. 3 (a).

In the case where the peripheral 40-1 is not used, for example, ‘0x1’ is set in the mode setting register 36.

When the value of the mode setting register 36 is “0x1”, the address decoder 31 decodes the address AD to one out of RAMs 35-1, 35-2 and 43-1. The selector 42-1 of the peripheral 40-1 selects the address AD, R/W control signal CS, and the write data WD from the RAM control circuit 30 according to the value of the mode setting register 36, and provides the RAM 43-1 with the above selected address, signal, and data. The selector 42-2 of the peripherals 40-2 selects the address AD, R/W control signal CS, and the write data WD from the control circuit 41-2 according to the value of the mode setting register 36, and provides the RAM 43-2 with the above selected address, signal, and data. The RAM address map viewed from the master 20 in the case where ‘0x1’ is set in the mode setting register 36 as explained before, is shown in FIG. 3 (b).

In the case where the peripheral 40-2 is not used, for example, ‘0x2’ is set in the mode setting register 36.

When the value of the mode setting register 36 is “0x2”, the address decoders 31 decodes the address AD to one out of RAMs 35-1, 35-2 and 43-2. The selector 42-1 of the peripherals 40-1 selects the address AD, R/W control signal CS, and the write data WD from the control circuit 41-1 according to the value of the mode setting register 36, and provides the RAM 43-1 with the above selected address, signal, and data. The selector 42-2 of the peripherals 40-2 selects the address AD, R/W control signal CS, and the write data WD from the RAM control circuit 30 according to the value of the mode setting register 36, and provides the RAM 43-2 with the above selected address, signal, and data. The RAM address map viewed from the master 20 in the case where ‘0x2’ is set in the mode setting register 36 as explained before, is shown in FIG. 3 (c).

In the case where either of the peripherals 40-1, 40-2 is not used, for example, ‘0x3’ is set in the mode setting register 36.

When the value of the mode setting register 36 is “0x3”, the address decoder 31 decodes the address AD to one out of RAMs 35-1, 35-2, 43-1, and 43-2. The selector 42-1 of the peripherals 40-1 selects the address AD, R/W control signal CS, and the write data WD from the control circuit 41-1 according to the value of the mode setting register 36, and provides the RAM 43-1 with the above selected address, signal, and data. The selector 42-2 of the peripherals 40-2 selects the address AD, R/W control signal CS, and the write data WD from the RAM control circuit 30 according to the value of the mode setting register 36, and provides the RAM 43-2 with the above selected address, signal, and data. The RAM address map viewed from the master 20 in the case where ‘0x3’ is set in the mode setting register 36 as explained before, is shown in FIG. 3 (d).

Effect of the First Embodiment:

According to the first embodiment, in the case where either of the peripherals 40-1, 40-2 including the built-in RAMs 43-1, 43-2, respectively, is not used, the above built-in RAMs 43-1, 43-2 can be used as accessible RAMs from the outside master 20, and then wider requests can be accepted.

### Second Embodiment

Configuration of the Second Embodiment:

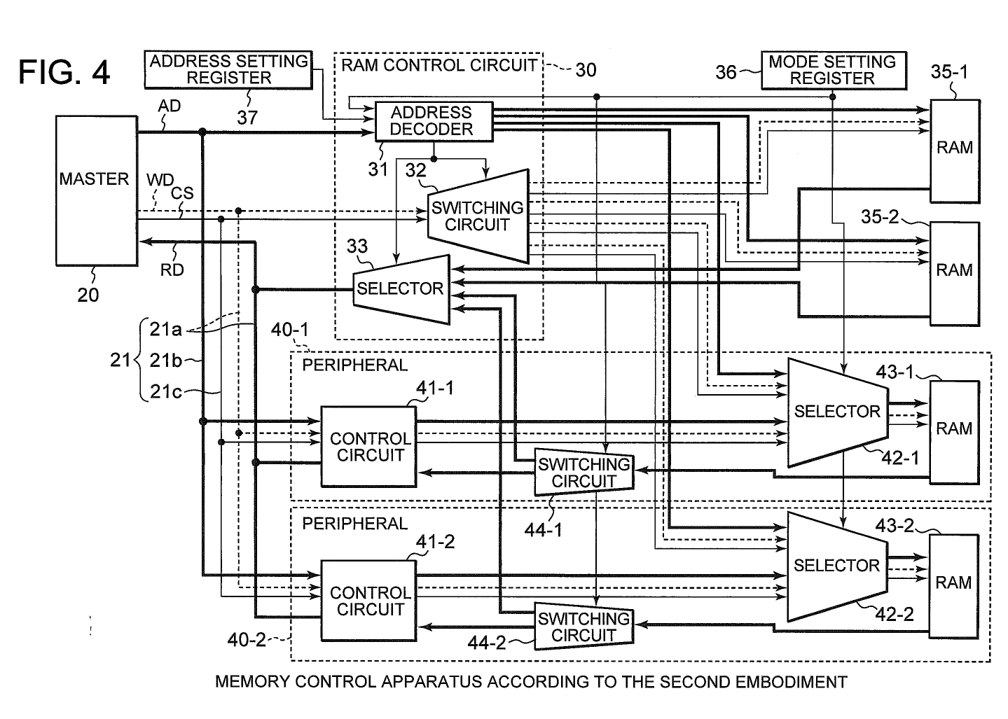

FIG. 4 is a view of general configuration diagram of the memory control apparatus according to the second embodiment. The elements identical to ones in the FIG. 1 of the first embodiment are given the same numerals as in FIG. 1.

An address setting device (for example, an address register) 37 newly added to the memory control apparatus according to the first embodiment is included in the memory control apparatus according to the second embodiment, and correspondingly a RAM control circuit 30A having a different configuration from the RAM control circuit 30 according to the first embodiment is included instead of the above RAM control circuit 30. The address setting register 37 sets start addresses to the RAMs 35-1, 35-2, 43-1, 43-2 (starting address) and provides the RAM control circuit 30A with the above start addresses.

The RAM control circuit 30A includes an address decoder 31A having a different configuration from the address decoder 31 according to the first embodiment, and a switching circuit 32 and a selector 33 having the same configurations as in the first embodiment. The address decoder 31A decodes an address AD to one out of RAMs 35-1, 35-2, 43-1, and 43-2, by comparing a start address set by the address setting register 37 with the address AD from a master 20.

Operation of the Second Embodiment:

Start address for each of the RAMs 35-1, 35-2, 43-1, 43-2 is set in the address setting register 37 so that any of the above start addresses does not overlap each other. For example, when the RAM is assigned at from address 0x00004000 to address 0x00007FFF, the start address is set to 0x0004000. For example, when the RAM 35-1 is assigned at from address 0x0004000 to address 0x00007FFF, the start address of the RAM 35-2 can be set to more than 0x00008000.

Assuming that the start addresses of the RAMs 35-1 and 35-2 overlap each other, in the case of write, the same data is written to both of the overlapped addresses of the RAMs 35-1 and 35-2. In the case of read, the data are read out from the overlapped addresses of the RAMs 35-1 and 35-2, respectively, and then the operation is done as if it were only one RAM. Subsequently, any effect of expanding memory, etc. cannot be achieved.

When an access from the master 20 occurs after the start address is set in the address setting register 37, the address decoder 31A compares the value set in the address setting register 37 with the address AD from the master 20, and decodes the address AD to one out of the RAMs 35-1, 35-2, 43-1, and 43-2. Other operations are the same as in the first embodiment.

Effect of the Second Embodiment:

According to the second embodiment, since the address setting register 37 is included, a start address to each of the RAMs 35-1, 35-2, 43-1, 43-2 can be set to a given value. Consequently, there is no need to install each of start addresses to the RAMs 35-1, 35-2, 43-1, 43-2 with respect to each mode in the mode setting register 36 in the apparatus thereof, and then reusability of the memory control apparatus is improved so much that developing period of LSI, etc. can be shortened.

For example, in the case of where the capacities of built-in RAMs 35-1, 35-2 or the configurations of peripherals 40-1, 40-2 vary with products, address maps of the RAM obviously vary, and then the address maps cannot be reused without modification, subsequently the device needs to be redesigned. Meanwhile, according to the second embodiment, since a start address assigned to the RAM can be changed freely on the software by the address setting register 37, the device can be used without modification in terms of hardware. Consequently, reusability of the memory control apparatus is improved so much that developing period of LSI, etc. can be shortened.

What is claimed is:

1. A memory control apparatus being characterized by comprising;
a peripheral being configured to include a built-in memory storing data:
a master being configured to output an address to said main memory and said built-in memory and access said main memory and said built-in memory;
a mode setting device being configured to set an access mode of the access object to said main memory and said built-in memory;
a decoding device being configured to decode said address from said master according to said set access mode and output decoding results thereof; and
a selector being configured to select an access information including said decoding results given to said built-in memory corresponding to said set access mode;

2. The memory control apparatus according to claim 1 being characterized by further comprising;
an address setting device being configured to set start addresses of said main memory and said built-in memory, and provide said address decoding device with said set start addresses so that said address decoding device decodes said set start address comparing said set start address with said address from said master.

3. The memory control apparatus according to claim 1, wherein said master, said main memory, and said peripheral are connected to each other through a bus.

4. The memory control apparatus according to claim 1, wherein said main memory and said built-in memory are memories rewritable and readable at any time.

5. The memory control apparatus according to claim 1, wherein said mode setting device is a mode setting register.

6. The memory control apparatus according to claim 1, wherein said decoding device is a decoding circuit.

7. The memory control apparatus according to claim 1, wherein said address setting device is an address setting register.
